(19) United States
(12) Patent Application Publication
(10) Pub. No.: US 2003/0173915 A1
(43) Pub. Date: Sep. 18, 2003

(54) Device for controlling rotation rate of the fan and rate-determining method thereof

(76) Inventors: Wen-Huang Lee, Taipei (TW); Chin-Chun Liao, Taipei (TW); Tzu-Shiou Yang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/370,342

(22) Filed: Feb. 20, 2003

(30) Foreign Application Priority Data
Feb. 20, 2002 (TW) 091102970

(51) Int. Cl. H02P 7/00

(52) U.S. Cl. 318/268

(57) ABSTRACT

A fan rotation rate control device and the method thereof for controlling the rotation rate of the fan are provided. The fan outputs actual rotation rates and the control device includes a fan, a control unit, a processing unit and a thermal sensing unit. The thermal sensing unit is used to sense the temperature inside the heat generating device or the temperature of the heat source therein and outputs thermal sensing signals accordingly; the processing unit is coupled to the thermal sensing unit and receives the thermal sensing signal on which the determination of the preset rotation rate is based. Of which, the control unit which is coupled to the processing unit and the fan receives the preset and the actual rotation rates, while the control unit outputs modulation signals to the fan according to the difference between the actual and the preset rotation rates to achieve a precise control of the fan.

This application claims the benefit of Taiwan application Serial No. 091102970, filed Feb. 20, 2002.

### BACKGROUND OF THE INVENTION

1. Field of the Invention

The invention relates in general to a thermal control unit for determining the preset rotation rate of the fan and the rate-determining method thereof, and more particularly to a fan rotation rate control unit that controls fan rotation rate accurately by means of a control unit and the method thereof.

2. Description of the Related Art

For people who live in today's society where science and technology are making rapid progress, the use of computer has become indispensable in their daily lives. Moreover, the introduction of notebook computer has brought further convenience to them. Owing to the advantageous features of compactness and handiness of the notebook computer, modern people can use it to handle their matters and business whenever and wherever they need to.

Computer and notebook computer are mainly composed of a central processing unit (CPU) serving as the operating center. Since the users require their computers with faster processing capability, the CPU needs to be designed to operate in an increased operating frequency. The CPU operating frequency nowadays has even reached a level of above 1 GHz. Obviously, the design and use of high CPU operating frequency become a natural trend. Nevertheless, a high-speed and powerful CPU must be accompanied by a high efficiency heat dissipation device. Most of the heat dissipation devices use a heat sink and a fan controller to enhance heat dissipation. Take the fan controller for example. In order to maintain a normal operation of the CPU, the fan controller is normally coupled to the CPU so that the heat generated during the operation can be dissipated outside. In this way, damage to the CPU, as well as reduction in CPU performance, due to the CPU under a high temperature can be avoided. The operation of the fan is illustrated below.

Please refer to FIG. 1, a diagram illustrating a thermal sensing unit, a processing unit, and a fan. In FIG. 1, thermal sensing unit 104 detects the peripheral temperature of fan 106. For instance, thermal sensing unit 104 detects the temperature of the CPU and obtains temperature T, the peripheral temperature of fan 106. When the peripheral temperature of fan 106 is sensed to be higher than a level specified by the safety standard for the CPU, thermal sensing unit 104 outputs a thermal sensing signal T according to the peripheral temperature of fan 106. Processing unit 105, which is coupled to thermal sensing unit 104, receives thermal sensing signal T, and determines a preset rotation rate P of fan 106, wherein processing unit 105 can be a processor. Fan 106, which is coupled to processing unit 105 and the CPU, receives the preset rotation rate P to enable fan 106 to rotate at an actual rotation rate A. It is noteworthy that preset rotation rate P and actual rotation rate A can be frequency signals. However, when tilted installation, aging problem or temperature change in the peripheral environment occurs to fan 106, a constant actual rotation rate A which is equal to preset rotation rate P can no longer be maintained. Consequently, difference arises between the actual rotation rate A and the preset rotation rate P. When actual rotation rate A is lager than preset rotation rate P, i.e., fan 106 is turning too fast, fan 106 will create undesirable noises or even an excessive electromagnetic interference effect (EMI effect). On the other hand, when actual rotation rate A is smaller than preset rotation rate P, i.e., fan 106 is turning too slow, fan 106 will not be able to dissipate the heat generated during the operation of the CPU, so a desired heat dissipation effect cannot be achieved. An unstable rotation rate of fan 106 prevents fan 106 from dissipating the heat generated during the operation of the CPU outside, reducing the performance of the CPU.

### SUMMARY OF THE INVENTION

It is therefore an object of the invention to provide a fan rotation rate control device and the method thereof. The design of the control unit can check the difference between the preset and actual rotation rate and adjust the modulation signal accordingly such that the actual fan rotation rate can be maintained at a constant level and equal to the preset rotation rate, facilitating a heat dissipation effect.

It is another object of the invention to provide a fan rotation rate control device installed in a heat generating device controlling the rotation rate of the fan. The fan outputs actual rotation rates. The control device includes a fan, a control unit, a processing unit and a thermal sensing unit wherein the thermal sensing unit is used to sense the temperature inside the thermal generating device or the temperature of the heat source therein. The processing unit, which is coupled to the thermal control unit, receives a thermal signal on which the determination of the preset rotation rate of the fan is based. Of which, the control unit outputs a modulation signal to the fan according to the difference between the actual and the preset rotation rates to achieve a precise control of the rotation rate of the fan.

Moreover, a method for controlling fan rotation rate is provided according to another object of the invention wherein the fan outputs actual rotation rates. In this control method, first of all, a thermal sensing signal is outputted. Next, receive the thermal sensing signal on which the determination of the preset rotation rate of the fan is based accordingly. Then, receive the preset rotation rate and output a modulation signal to the fan accordingly. Following that, check the difference between the actual and the preset rotation rates. Last, adjust the modulation signal to achieve a precise control of the fan according to the difference between the actual and the preset rotation rates.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram for a thermal sensing unit, a processing unit and a fan;

FIG. 2 is a block diagram for a fan rotation rate control device according to the invention; and

FIG. 3 is a flowchart for a fan rotation rate control device according to a preferred embodiment of the invention.

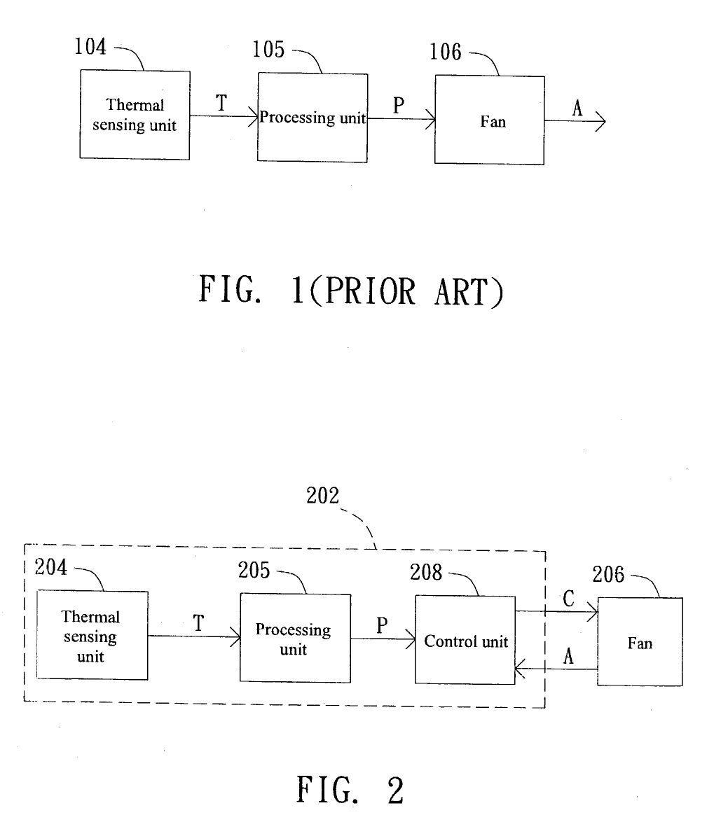

### DETAILED DESCRIPTION OF THE INVENTION

A fan rotation rate control device and method is provided according to the design of the invention. With the design of a fan rotation rate control device, the actual rotation rate of the fan is allowed to be maintained at a fixed level which equals that of the preset rotation rate to achieve an expected heat dissipation effect. The rotation rate control device and method is described in a preferred embodiment of the invention accompanied by drawings.

Please refer to FIG. 2, a block diagram for a fan rotation rate control device according to the invention. In FIG. 2, a fan rotation rate control device 202 is installed in a heat generating device, a desk-top computer or a notebook computer for instance. Fan rotation rate control device 202 includes a thermal sensing unit 204, a processing unit 205 and a control unit 208. Thermal sensing unit 204 is used to sense the temperature inside the heat generating device or the temperature of the heat source therein. The heat source can be a CPU, a hard disk or chip set. Take a notebook computer for example; thermal sensing unit 204 is used to sense the temperature inside the notebook computer or the temperature of the CPU. When sensing a temperature higher than the preset safety standard, thermal sensing unit 204 will output a thermal sensing signal T according to the temperature inside the notebook computer or the temperature of the CPU therein. Processing unit 205, which is coupled to thermal sensing unit 204, receives the thermal sensing signal T on which the determination of preset rotation rate P of fan 206 is based facilitating the operation of fan 206. Processing unit 205 cap be a processor.

It is noteworthy that preset rotation rate P varies with the temperature sensed by thermal sensing unit 206. For example, when the temperature sensed by thermal sensing unit 206 is 50° C., 70° C. and 90° C. respectively, the user can previously set preset rotation rate P corresponding to 50° C., 70° C. and 90° C. to be 3000 rpm, 4000 rpm and 5000 rpm in advance.

Control unit 208, which is coupled to processing unit 205, is used to receive preset rotation rate P and actual rotation rate A of fan 206. Furthermore, control unit 208 outputs a modulation signal C according to the difference between preset rotation rate P and actual rotation rate A. Moreover, fan 206, which is used to receive the modulation signal C, adjusts the rotation rate of fan 206 according to modulation signal C and outputs actual rotation rate A. It is noteworthy that preset rotation rate P and actual rotation rate A can be of frequency signals while modulation signal C is a pulse width modulation signal.

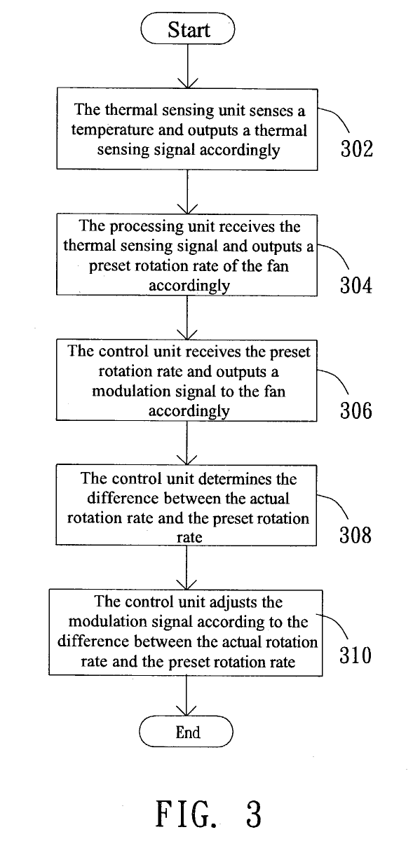

FIG. 3 is a flowchart for a fan rotation rate control device according to a preferred embodiment of the invention. Meanwhile, please refer to FIG. 2. In FIG. 3, first, step 302 is performed where thermal sensing unit 204 detects a temperature and outputs a thermal sensing signal T accordingly. The temperature can be the temperature inside the heat generating device or the temperature of the heat source therein. Next, go to step 304: processing unit 205 which is coupled to thermal sensing unit 204 receives the thermal sensing signal T on which the determination of preset rotation rate P of fan 208 is based. After that, go to step 306: control unit 208, coupled to processing unit 205 and fan 206, receives preset rotation rate P and outputs a modulation signal C to fan 206. Next, the method proceeds to step 308: control unit 208 receives actual rotation rate A of the fan and determines the difference between actual rotation rate A and preset rotation rate P. Next, go to step 310: control unit 208 adjusts modulation signal C according to the difference between actual rotation rate A and preset rotation rate P to achieve a precise control of the rotation rate of fan 206.

When the actual rotation rate A is larger than preset rotation rate P, control unit 208 will adjust modulation signal C such that actual rotation rate A can change and become substantially equal to preset rotation rate P, avoiding undesirable noises and excessive EMI effect arising from an excessive rotation rate of the fan. On the other hand, when sensing that actual rotation rate A is smaller than preset rotation rate P, control unit 208 will adjust modulation signal C such that actual rotation rate A can change and become virtually equal to preset rotation rate P, avoiding a poor heat dissipation effect. Moreover, the invention can set up such a criterion: if the difference between actual rotation rate A and preset rotation rate P is within a preset range of tolerance, say, 5%, end this method, otherwise continue the execution of the method until actual rotation rate A and preset rotation rate P are virtually equal.

The invention introduces control unit 208 which receives preset rotation rate P of fan 206 as well as actual rotation rate A. Control unit 208 checks the difference between preset rotation rate P and actual rotation rate A and adjusts modulation signal C according to this difference, allowing actual rotation rate A to be maintained at a fixed level and become virtually equal to preset rotation rate P to achieve a desired heat dissipation effect of fan 208.

A fan rotation rate control device and the method thereof are disclosed above. The control unit is designed to detect the difference between preset and actual rotation rate and to adjust modulation signal C according to the detected difference so that the actual rotation rate A of the fan can be maintained at a fixed level and becomes substantially equal to that of the preset rotation rate P. Therefore, the enhancement of heat dissipation of the fan can be achieved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fan rotation rate control device used to control the rotation rate of a fan wherein the fan outputs an actual rotation rate and the fan rotation rate control unit comprises:
a thermal sensing unit used to sense the temperature of a heat source and output a thermal sensing signal;
a processing unit which is coupled to the thermal sensing unit and is used to receive the thermal sensing signal on which the determination of a preset rotation rate of the fan is based; and
a control unit which is coupled to the processing unit and the fan and is used to receive the preset rotation rate and the actual rotation rate wherein the control unit output a modulation signal to the fan according to the difference between the actual and the preset rotation rates to achieve a precise control of the rotation rate of the fan.

2. The fan rotation rate control device according to claim 1, wherein the modulation signal is a pulse width modulation signal.

3. The fan rotation rate control device according to claim 1, wherein the heat source is a central processing unit (CPU).

4. The fan rotation rate control device according to claim 1, wherein the heat source is a hard disk.

5. The fan rotation rate control device according to claim 1, wherein the heat source is a chip set.

6. A fan rotation rate control device installed inside a heat generating device for controlling the rotation rate of a fan, wherein the fan outputs an actual rotation rate and the fan rotation rate control device further comprises:
a thermal sensing unit used to sense the temperature inside the heat generating device and output a thermal sensing signal accordingly;
a processing unit which is coupled to the thermal sensing unit and is used to receive the thermal sensing signal on which the determination of a preset rotation rate of the fan is based; and
a control unit which is coupled to the processing unit and the fan and is used to receive the preset rotation rate and the actual rotation rate wherein the control unit outputs a modulation signal to the fan according to the difference between the actual and the preset rotation rates to achieve a precise control of the rotation rate of the fan.

7. The fan-rotation rate control device according to claim 6, wherein the modulation signal is a pulse width modulation signal.

8. The fan rotation rate control device according to claim 6, wherein the heat generating device is a desk top computer.

9. The fan rotation rate control device according to claim 6, wherein the heat generating device is a notebook computer.

10. The fan rotation rate control method for controlling the rotation rate of a fan, wherein the fan outputs an actual rotation rate and the fan rotation rate control method comprises the steps of:
outputting a thermal sensing signal;
receiving the thermal sensing signal and determining a preset rotation rate of the fan accordingly;
receiving the preset rotation rate and outputting a modulation signal to the fan accordingly;
determining the difference between the actual rotation rate and the preset rotation rate; and
adjusting the modulation signal to achieve a precise control of the rotation rate of the fan according to the difference between the actual rotation rate and the preset rotation rate.

11. The fan rotation rate control method according to claim 10 wherein the modulation signal is a pulse width modulation signal.

12. The fan rotation rate control method according to claim 10 further comprises the step of:
sensing the temperature of a heat source and outputting the thermal sensing signal accordingly.

13. The fan rotation rate control method according to claim 12 wherein the heat source is a central processing unit.

14. The fan rotation rate control method according to claim 12 wherein the heat source is a hard disk.

15. The fan rotation rate control method according to claim 12 wherein the heat source is a chip set.

16. The fan rotation rate control method according to claim 10 further comprises the step of:
sensing the temperature of a heat generating device and outputting the thermal sensing signal accordingly.

17. The fan rotation rate control method according to claim 12 wherein the heat generating device is desk top computer.

18. The fan rotation rate control method according to claim 12 wherein the heat generating device is a notebook computer.
